(19) United States
(12) Patent Application Publication
(10) Pub. No.: US 2003/0061490 A1
(43) Pub. Date: Mar. 27, 2003

(54) Method for identifying copyright infringement violations by fingerprint detection

(76) Inventor: Aram Christian Abajian, Seattle, WA (US)

Correspondence Address: THOMSON Multimedia Licensing Inc., Patent Operations, Two Independence Way, P.O. Box 5312, Princeton, NJ, 08543-5312, US

(21) Appl. No.: 10/252,903

(22) Filed: Sep. 23, 2002

Related U.S. Application Data
(60) Provisional application No. 60/324,860, filed on Sep. 26, 2001.

(51) Int. Cl. H04L 9/00

(52) U.S. Cl. 713/176; 713/200

(57) ABSTRACT

A method for locating media objects that violate the copyright of copyright holders through the use of a fingerprinting media objects. The system develops a fingerprint profile for a specified media object, matches the fingerprint profile against the fingerprint profiles of located media objects. Based upon the data of matched media objects, the method outputs the location of matched media objects as a uniform resource indicator. The method optionally considers a user profile before matching a fingerprint profile of a specified media object against fingerprint profiles of located media objects.

### CROSS-REFERENCE TO RELATED APPLICATIONS

This application claims priority from U.S. provisional application No. 60/324,860, filed on Sep. 26, 2001.

### FIELD OF THE INVENTION

The present invention relates to multimedia searches, and more specifically multimedia searches for specific multimedia objects identified by physical attributes through the use of a fingerprint profile.

### BACKGROUND

An aspect of the Internet (also referred to as the World Wide Web, or Web) that has contributed to its popularity is the plethora of multimedia and streaming media objects available to users. However, finding a specific multimedia or media objects buried among the millions of files on the Web is often an extremely difficult task. The volume and variety of informational content available on the web is likely continue to increase at a rather substantial pace. This growth, combined with the highly decentralized nature of the web, creates substantial difficulty in locating particular informational content.

Media objects refers to audio, video, multimedia, textual, and interactive data files that are delivered to a user's computer via the Internet or other communication network. Media objects also includes streaming media files that are transferred through a networked environment and begin to play on the user's computer before delivery of the entire file is completed. Examples of media objects included digitally recorded music, movies, trailers, news reports; radio broadcasts; and live events that are available through the Internet. Means for accessing the Internet (or other communications networks) to obtain media files include such high-bandwidth connections such as cable, DSL and T1 communication lines.

One problem with the availability of multimedia objects through the Internet is that many objects are made available through illegal means. For example, it is common for people to post music files to that have been taken or “ripped” from Compact Discs illegally, where such ripped files infringe the copyrights of the music's composers or owners. More specifically, through the use of digital compression, it is possible to post complete videos of television shows and movies, without the consent of the copyright owners of such media. Therefore, the movie and music industries have become interested in methods of monitoring the illicit use of media objects available through communications networks, such as the Internet, through the use of Digital Resource Management (DRM).

One approach for identifying media objects through DRM compares the metadata associated with a media file, such as file name, Universal Resource Indicator, or information such as the title directly encoded in the file, to a database of metadata associated with known media files. The presumption is that copyrighted material would possess the same metadata even after being copied (whether such copying was authorized or not, as metadata may be part of a media object at the time it is generated). The disadvantage of comparing metadata of a media object against metadata in a database is that the metadata from a media object may be intentionally modified. For example, if the title metadata of a media object were illicitly changed, it would be difficult for the DRM solution to correctly match and identify the media object. Therefore, other DRM approaches need to be utilized to identify potentially infringing copyright violators.

A second, but more accurate way, of identifying media objects (for the purposes of DRM) is by using the physical characteristics of media objects. A technique called fingerprinting makes is possible to determine if different media objects are derived from the same copyrighted source, even if those media objects have been encoded with different codecs (for example, one file is encoded with Real Player versus an MP3 codec) and at different bit rates, and as a result (compared on a byte-by-byte basis) differ significantly. Reliably, two files with the same or similar fingerprints are likely to be derived from the same source. Combined with a priori knowledge of who is the legitimate rights holder(s) to files derived from a particular source (i.e. with a common fingerprint), this information can be used in detecting intellectual property rights violations, in particular cases where the source of one or more of the files does not have permission from the rights holder(s) to redistribute the file (e.g. serving that file on their web or ftp storage site).

Although fingerprinting is an effective approach for identifying media objects, a problem exists for a copyright holder to identify copyrighted works available through a communications network because of the multitude of storage locations and web sites were such media objects might be located. Therefore, a need exists for a copyright holder to identify copyrighted works in simple, unified approach.

### SUMMARY OF THE INVENTION

A system for locating copyright infringers by locating media objects available through a communications network based on a developed fingerprint profile for a media object. The fingerprint profile of the media object is matched against the fingerprints of located media objects. Ancillary information related to matched media objects is outputted specifying locations of matched media objects.

### BRIEF DESCRIPTION OF THE DRAWINGS

The above and other advantages and features of the present invention will be better understood from the following detailed description of the preferred embodiments of the invention, which is provided in connection with the accompanying drawings. The various features of the drawings may not be to scale. Included in the drawing are the following figures:

FIG. 1 is a block diagram of a computer system in accordance with an exemplary embodiment of the present invention;

FIG. 2 is a flow diagram of an exemplary search and retrieval process in accordance with the present invention;

FIG. 3 is a functional block diagram of an exemplary multimedia and/or streaming media metadata search, retrieval, enhancement, and fingerprinting system in accordance with the present invention;

FIG. 4 is a flow diagram of a process of matching media objects based on fingerprint profiles.

FIG. 5 is a display of a front end used to operate the present invention.

### DETAILED DESCRIPTION

Although the invention is described in terms of exemplary embodiments, it is not limited thereto. Rather, the appended claims should be construed broadly, to include other variants and embodiments of the invention, which may be made by those skilled in the art without departing from the scope and range of equivalents of the invention.

The present invention is a system and method for retrieving media files and data related to media files on a computer network via a search system utilizing metadata. As used herein, the term “media object” includes audio, video, textual, multimedia data files, and streaming media files. Multimedia objects comprise any combination of text, image, video, and audio data. Streaming media comprises audio, video, multimedia, textual, and interactive data files that are delivered to a user's computer via the Internet or other communications network environment and begin to play on the user's computer/ device before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, the reduction in cost of communications networks through the use of high-bandwidth connections such as cable, DSL, T1 lines and wireless networks (e.g., 2.5G or 3G based cellular networks) are providing Internet users with speedier, more reliable access to streaming media content from news organizations, Hollywood studios, independent producers, record labels and even home users themselves.

Examples of streaming media include songs, political speeches, news broadcasts, movie trailers, live broadcasts, radio broadcasts, financial conference calls, live concerts, web-cam footage, and other special events. Streaming media is encoded in various formats including REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3®. Typically, media files are designated with extensions (suffixes) indicating compatibility with specific formats. For example, media files (e.g., audio and video files) ending in one of the extensions, ram, .rm, .rpm, are compatible with the REALMEDIA® format. Some examples of file extensions and their compatible formats are listed in the Table 1. A more exhaustive list of media types, extensions and compatible formats may be found at http://www.bowers.cc/extensions2. htm.

TABLE 1

| Format | Extension |
|---|---|
| REALMEDIA ® | .ram, .rm, .rpm |
| APPLE QUICKTIME ® | .mov, .qif |
| MICROSOFT | .wma, .cmr, .avi |
| WINDOWS ® MEDIA | |
| PLAYER | |
| MACROMEDIA FLASH | .swf, .swl |
| MPEG | .mpg, .mpa, .mp1, |
| | .mp2 |
| MPEG-2 LAYER III | .mp3, .m3a, .m3u |
| Audio | |

Sources of metadata include web page content, uniform resource locators (URLs), media files, and transport streams used to transmit media files. Web page content includes HTML, XML, metatags, and any other text on the web page. As explained in more detail, herein, metadata may also be obtained from the URIs of web pages, media files, and other metadata. Metadata within the media file may include information contained in the media file, such as in a header or trailer, of a multimedia or streaming file, for example. Metadata may also be obtained from the media/ metadata transport stream, such as TCP/IP (e.g., packets), ATM, frame relay, cellular based transport schemes (e.g., cellular based telephone schemes), MPEG transport, HDTV broadcast, and wireless based transport, for example. Metadata may also be transmitted in a stream in parallel or as part of the stream used to transmit a media file (a High Definition television broadcast is transmitted on one stream and metadata, in the form of an electronic programming guide, is transmitted on a second stream).

One example of a fingerprinting technique relies on an open source application called SongPrint available through a General Public License. The algorithm used for SongPrint for fingerprinting is computationally efficient. A given media file (such as an audio object as an MP3) is analyzed, during an extraction mode, (as a reconstituted/decoded waveform) using a Discrete Fourier Transform (DFT). Specifically for SongPrint, the DFT used relies on the signal analysis described in the technical document “The Fastest Fourier Transform in the West” developed at MIT by Matteo Frigo and Stephen G. Johnson, the algorithm is available at www.fftw.org. SongPrint operates by analyzing the power (function) of an audio signal, into 16 separate audio bands of a specific frequency range. The power levels of these separate audio bands are then averaged over a region of the waveform, for a specific duration of time (the first 30 seconds of the waveform, for example). The resulting vector of 16 numbers is a fingerprint “fingerprint vector” or “fingerprint profile” and is highly likely to be unique for audio waveforms whose audio characteristics differ slightly, such as two different encodings of the same audio source. The invention may also be implemented using the AudioID™ fingerprinting system developed at the Fraunhofer-Gesellschaft available through http://www.emt.iis.fhg.de/produkte/.

Because it is possible for two unique fingerprints to exist for the same source recorded with different encoding techniques, it is possible to match similar fingerprints by calculating a precise measure of the degree of difference between two fingerprints. Specifically, a fingerprint of one audio file is mapped to a first vector (of 16 coordinates), a second fingerprint is mapped to a second vector where a distance formula (see Table 2) is used to calculate the distance between two points:

\sqrt{[(x1−y1)²+(x2−y2)²+. . . +(x16−y16)²]}

### Table 2

From the calculated distance from the two vectors, an effective “weighting” of the different bands is compared to a threshold value (as a distance) for determining if two fingerprints are from the “same” stream (i.e. represent the same CD track or QuickTime movie file). If the resulting distance (calculated from the two vectors) was less than a threshold distance, then it is probable that the fingerprints from two media objects are from the same source. If not, the two media objects are probably from different sources. The degree of confidence of a match between two fingerprints may be inversely modified so that the smaller the threshold distance, the more likely that two media objects are from the same source.

FIG. 1 is a block diagram illustrating a system, generally designated 100, in accordance with an exemplary embodiment of the present invention. The system 100 includes a plurality of server computers 18, 20, a plurality of user computers 12, 14, and a plurality of databases 21, 22. The server computers 18, 20 and the user computers 12, 14 may be connected by a communications network 16, such as for example, an Intranet or the Internet. The user computers 12, 14 may be connected to the Intranet or Internet by a modem connection, a Local Area Network (LAN), cable modem, digital subscriber line (DSL), or other equivalent coupling means. Alternatively, the computers communicate through a communications network by a cable, twisted pair, wireless based interface (cellular, infrared, radio waves) or equivalent connection utilizing data signals. Databases 21, 22 may be connected to the user computers and the server computers by any means known in the art. Databases may take the form of any appropriate type of memory (e.g., magnetic, optical, etc.). Databases 21, 22 may be external memory or located within the server computer or the user computer. Each user computer 12, 14 preferably includes a video display device for displaying information and a browser program (e.g. MICROSOFT INTERNET EXPLORER®, NETSCAPE NAVIGATOR®, etc.), as is well known in the art.

Computers may also encompass computers embedded within consumer products and other computers. For example, an embodiment of the present invention may comprise computers (as a processor) embedded within a television, a set top box, an audio/video receiver, a CD player, a VCR, a DVD player, a multimedia enable device (e.g., telephone), and an Internet enabled device.

In an exemplary embodiment of the invention, the server computers 18, 20 include one or more program modules and one or more databases which allow the user computers 12, 14 to communicate with the server computer, and each other, over the network 16. The program module(s) of the server computers 18, 20 include program code, written in PERL, Extensible Markup Language (XML), Java, Hypertext Mark-up Language (HTML), or any other equivalent language which allows the user computers 12, 14 to access the program module(s) of the server computer through the browser programs stored on the user computers. Although only two user computers 12, 14, two server computers 18, 20, and two databases 21, 22 are labeled in FIG. 1, those of ordinary skill in the art will realize that the system 100 may include any number of user computers, server computers, and databases.

In an exemplary embodiment of the present invention, media objects are available through network 16. Most media objects will be obtained through a source such as server 20, or databases as database 22 (such as a file storage site (FTP) through server 22. Media objects may also be obtained through a peer-to-peer networking system as implemented through decentralized servers available through computer programs as GNUELLA, NAPSTER, BEARSHARE, or other types of peer-to-peer networks.

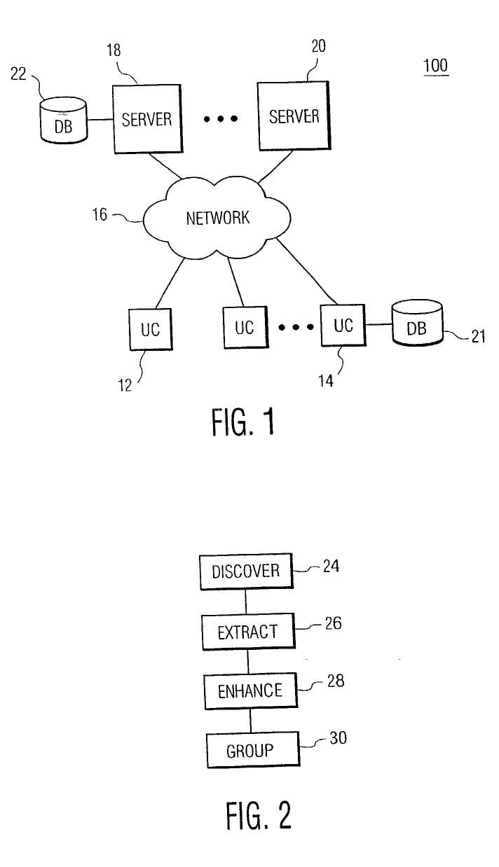

The contents of servers, databases, and other storage locations are searched by a tool known as a web crawler/search engine that are displayed in FIG. 2 as a flow diagram of an exemplary search and retrieval process in accordance with the present invention. Discovery (step 24) comprises an automated process referred to as a spider or web crawler, for searching web sites, data storage sites, or data available through a communications network. Each site containing media objects may comprise any number of web pages and/or data on storage devices (hard drives, flash cards, disc drives, optical disc storage). The spider utilizes predetermined algorithms to continuously search for media files on web pages and file directories at each searched web site. The spider also searches each web site for links to other web sites, unique streams, and downloadable files.

Upon finding a media file, metadata and fingerprinting information associated with that file is extracted (step 26). Metadata is extracted from sources such as the name of the media file, the MIME responses, links to the media file, text surrounding the media file on the website, metatags (descriptive information embedded in sources as program code or HTML) in or surround the media file, content partners supplying metadata about their files, and the results of reading the metadata of the media file with an interpretive extraction process. The fingerprinting of the media object is made with a module at the extraction step, where the media object is analyzed, and a vector representing a fingerprint is generated and stored with the metadata representative of a media file. Optionally, only fingerprint information from the media object is extracted because metadata is not as reliable as a fingerprint.

Extracted metadata and fingerprint vectors are enhanced in step 28. The extracted metadata associated the media files are stored in memory (e.g., transferred to a database). The metadata is assessed, analyzed, and organized in accordance with attributes associated with the media file. If metadata information is missing from the extracted metadata, it is added (step 28). If metadata information is incorrect, it is corrected (step 28). For example, if metadata associated with a song comprises the fields of Composer, Title, Musician, Album Name, and Music Genre, but is missing the date the song was copyrighted, the copyright date is added to the extracted metadata. The metadata (e.g., copyright date) used to enhance the extracted metadata is obtained from at least one of several sources. These sources include a baseline database of metadata associated with the search target (e.g., the particular song of interest) and the semantic and technical relationships between the fields in the extracted metadata.

The extracted metadata, which may be enhanced, is categorized in accordance with specific metadata and fingerprinting attributes in step 30. At this point the links representatives of a media object, e.g., uniform resource indicators (URIs) in the form of uniform resource locators (URLs) for web pages and data files and associated fingerprint vector and metadata, may be transferred to a database. Further processes at point of the database may continually group and match like media objects based upon similar metadata, fingerprint vectors, and other related information. Uniform resource indicators (URIs) are a universal set of names that refer to existing protocols or name spaces that identify resources (e.g., website, streaming media server,), services (e.g., videos on demand, internet radio), devices (e.g., mobile phone, internet enable appliance), and data files (e.g., media files and text documents). A URL is a form of a URI that expresses an address that maps to an access algorithm using network protocols (e.g., TCP/IP or a MPEG transport scheme). When a URL is used, a specific resource, service, device, or data file may be accessed and/or manipulated. An alternative form of a URI known as an Internet protocol number or address (IP) is a series of numbers that refers to a specific resource, service, or data file. Optionally, a URL is mapped to an IP number, which provides two ways to access a desired resource (e.g., a resource is accessed either by using www.whitehouse.gov or the IP address 198.137.240.91).

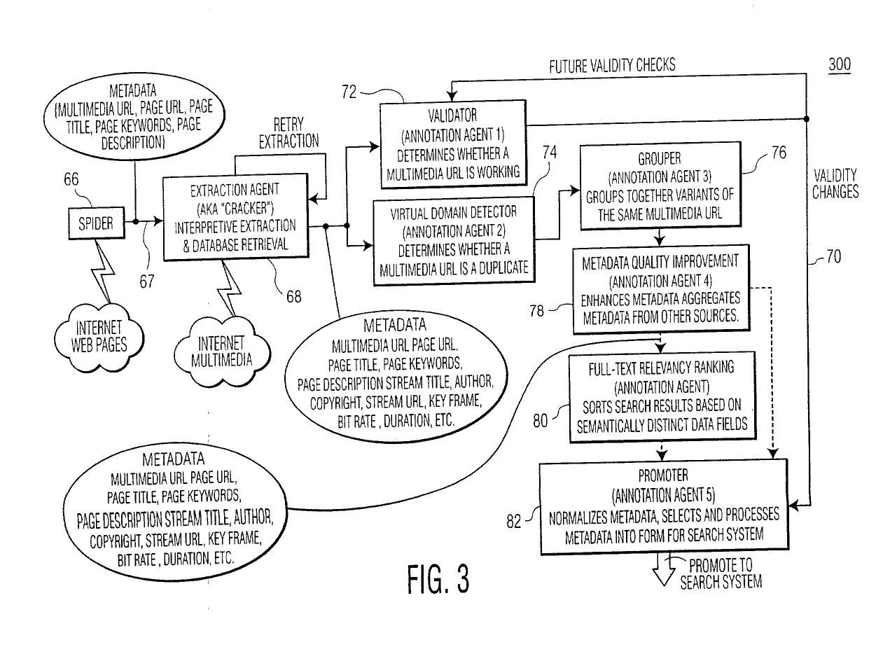

FIG. 3 is a functional block diagram of an exemplary search, retrieval, and fingerprinting system, designated 300, in accordance with the present invention. System 300 comprises a plurality of autonomous, interacting agents for collecting, extracting, enhancing, and grouping media metadata. Although system 300 depicts the agents performing in an exemplary order, agents may perform respective functions in any order. Each agent receives and provides data from and to data queues. Data residing on a data queue is available to all agents. In an exemplary embodiment of the invention, media files and associated metadata are stored in memory (e.g., a database) and assigned an identifier (id). The ids are enqueued, and the agents receive and provide the ids from and to the queues. Agents retrieve associated data (e.g., metadata) from memory to perform various functions, and store the processed data in memory (e.g., update the database).

Spider 66 incorporates a process of seeding to search for media and related files. The spider seeds its search by adding terms that are related to the query being used to index media. Additionally, the spider adds media related terms to the search, such as “MP3” and “Real Audio”. Adding media related terms to the search tend to limit the search to media related files and URIs (in the form of links). For example, adding streaming media related terms to the search tends to limit the search to streaming media related files and links. The spider receives the search results and uses the links to perform more searches. The input queue of the spider may be seeded with several types of information, such as the results of querying other search engines, manually generated sets of web page URLs, and processing proxy cache logs (i.e., web sites that other users have accessed).

Referring again to FIG. 3, the parsed results relating to the media objects are passed to extraction agent 68 via an extraction queue 67. Results not associated with the media are not pursued. The extraction queue 67 comprises URLs to be analyzed with respect to associated media metadata. The extraction queue 67 may comprise metadata queue entries such as media URLs, Web page URLs, Web page titles, Web page keywords, Web page descriptions, media title, media author, and media genre. Each queue entry added to the extraction queue is assigned a processing time and a priority. In an exemplary embodiment of the invention, each queue entry is given a processing time of “now” and the same default priority. The iterative seeding process increases the number of queue entries added to the extraction queue 67.

The extraction agent 68 comprises an interpretive metadata extractor and a database retriever. The extraction agent 68 distributes and performs enhanced metadata extraction of queue entries on the extraction queue 67. The extraction queue entries are dequeued and distributed in priority and time order. Preferably, the file extension, MIME type, and/or file identification for each queue entry is examined to determine the type of media format. The queue entry is than sent to the appropriate media specific extractor. Optionally, other types of data are used to determine the media format of a file (for example, the extraction queue 67 reads the metadata embedded in a media file to determine that it is a Real Media video file).

Extraction agent 68 captures and aggregates media specific metadata and fingerprint information pertaining to the media (including multimedia and streaming media) from sources such as the media URL, the referring Web page URL, title, key words, description, and third party databases. This step in the workflow will utilize the fingerprinting algorithm to associate a fingerprint vector to a media object. The extraction agent 68 runs a fingerprint module, as stated above, to generate a fingerprint vector for a specific media object.

Referring again to FIG. 3, the validator 72 dequeues entries from the queue in time and priority order. The validator 72 validates the media data by determining if the Web page comprises a link to a desired media file and also determining if the desired media file works. Validation is performed at a future point in time (e.g., check if the URL is still alive in 3 days), or alternatively, at periodic future points in time. If validity changes from valid to invalid, a notification is sent to promoter 82, as indicated by arrow 70. Validity may change from valid to invalid, for example, if the media file was removed from the linking URL.

The virtual domain detector 74 dequeues data from the queue in time and priority order. The virtual domain detector 74 looks for duplicate domains (field of the URL). If duplicates are found, they are identified as such and queued. The queued ids are available to all agents.

It is not uncommon for Web pages and multiple servers with different portions of a URL, e.g., different domains, to host the same media content. Further, the same media content may be available in different formats and bit rates. The grouper 76 analyzes and compares URLs in the database. The grouper 76 combines variants of the same media URL and creates a group in which all metadata for similar URLs are added to the group. URLs are analyzed to determine if they are variations of related files. For example, if two URLs share a very complex path that differs only in the file extension, the two URLs are considered to be related. Differences are eliminated by masking out tokens at the same relative location with respect to the original string.

Referring again to FIG. 3, metadata quality improver 78 dequeues entries in time and priority order. Metadata quality improver 78 enhances metadata by adding fields of metadata based upon the contents of the fields in the URL of the media file and the contents of the fields in the URL of the referring Web page. The media file is then searchable under the subject heading of the added metadata. For example, a streaming media file may have a referring Web page at www.cnn.com. The metadata quality improver 78 adds the term “news” to the metadata associated with the streaming media file, because cnn is related to news. As a result, the streaming media file is now searchable under the subject heading of “news”. Expert based rules are used to associate field contents with metadata. Metadata quality improver 78 applies rules to eliminate duplicate URLs that point to the same data, rules to collect variants of media files with the same content but different encodings or formats (e.g., for multimedia and streaming media), and rules to update metadata fields using prefix URL associations. The metadata quality improvement process comprises prefix rule evaluation, genre annotation, and MUZE® (a commercial database containing metadata about music including song title, music author, and album information) annotation.

The full-text relevancy ranker 80 comprises ranking and sorting data (e.g., media metadata) based on a variety of semantic and technical data fields (e.g., title, author, date, duration, bit rate, fingerprinting, etc.). Full-text relevancy ranker 80 is depicted as part of the work flow architecture of system 300. This depiction is exemplary. In another embodiment of the invention, full-text relevancy ranker 80 is not part of the workflow architecture. The option to include full-text relevancy ranker 80 as part of the workflow architecture (or not) is depicted by the dashed arrows in FIG. 3 (from metadata quality improver 78 to full-text relevancy ranker 80, from full-text relevancy ranker 80 to promoter 82, and from metadata quality improver 78 to promoter 82).

Promoter 82, formats and prioritizes data for a target search system (e.g., search engine). Promoter 82 adds, deletes, and/or updates the data (including metadata) associated with a media file in accordance with the requirements of the target search system. Promoter 82 also provides an indication to the search system of the trustworthiness of the media data and fingerprint profile/vector. In an exemplary embodiment of the system, trustworthiness is determined in accordance with predetermined encoded rules. For example, promoter 82 may determine that metadata associated with the title fields is the most trustworthy, and that metadata associated with the genre fields is less trustworthy as to match metadata to a fingerprint vector of a media object. This hierarchy of trustworthiness is provided to the target search system in a compatible format. The target search system may then use this hierarchy of trustworthiness to conduct its search or pass the URIs to a database or a user.

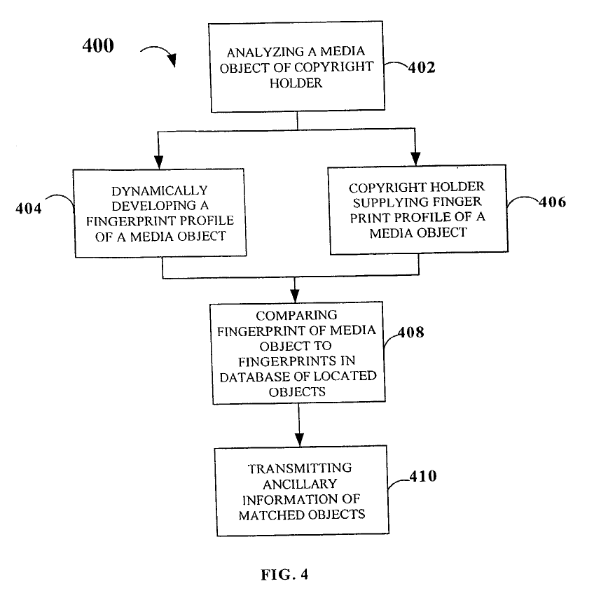

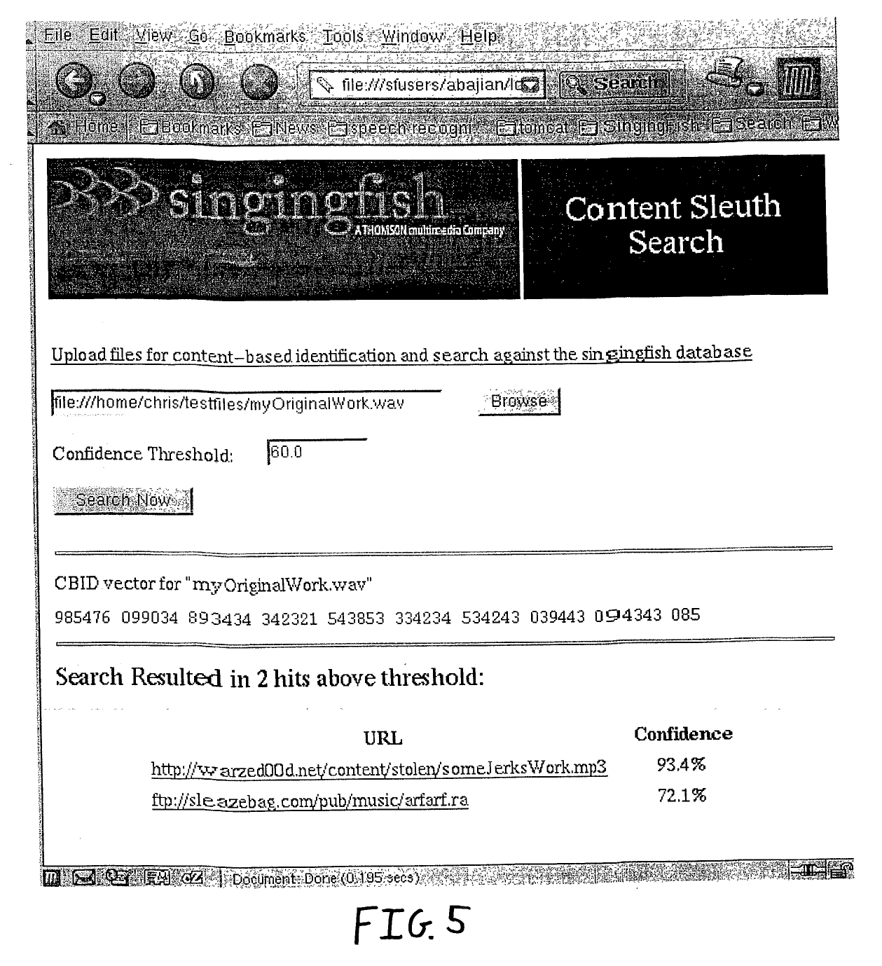

FIG. 4 is an exemplary embodiment of the invention as a method 400 utilizing DRM to locate media objects through the communications network via fingerprint information. Step 402 begins with the DRM solution analyzing a media object of a copyright holder. The owner of a media object will initialize the service of locating copies copyrighted media objects available through the Internet. The copyright holder would access the point where the DRM solution is available and request that a copyrighted media object be located. One exemplary embodiment of the invention is listed in FIG. 5, denoting an example of the front end for the invention, serving as the interface for a copyright holder to utilize aspects of this invention.

At the time the copyright holder accesses the front end of DRM solution (in step 402), the copyright holder may be queried to provide access information before the solution is completely available. Examples of access information include a username profile, password, and payment information that would be used to debit money or credits from a copyright holder's account. Step 402 may also provide a copyright holder with the means of subscribing to the service provided by the invention. The copyright holder would be prompted for identification and payment information before the DRM service of the invention is available to the copyright holder.

After accessing the front end during step 402, the copyright holder is prompted for a media object to be analyzed. Step 404 provides the option of having a media object dynamically analyzed by the DRM solution as to develop a fingerprint profile of a media object. In one exemplary embodiment of the invention, as displayed in FIG. 5, the copyright holder supplies a URI of the location of a media object to be analyzed. The DRM solution would utilize components of the work architecture denoted in FIG. 3, where a webcrawler, as a data analyzer, would go to the location of the specified media object. An extractor component of the workflow architecture would extract a fingerprint profile (as a fingerprint vector) and optionally metadata from the media object using the method denoted above, although other fingerprinting methods may be used, as consistent with the principles of the invention.

Step 406 allows the copyright holder to supply a fingerprint profile of a media object directly. The copyright holder may already have analyzed media objects to develop a set of fingerprints, whereby a database of the fingerprints of media objects (generated by the analysis program) may be uploaded to the front end of the invention.

Using the information generated in steps 404 and 406, the invention matches the fingerprint profiles of specified media objects against the fingerprint profiles located in a database of the invention. The matching algorithm may comprise of a comparison performed in a SQL compatible environment, or other well-known approach of comparing queried data against data in a database, as database 21 in FIG. 1. In FIG. 5, a fingerprint profile (CBID vector) of a media object known as “myOriginalWork.wav” is compared to a database of fingerprints of located media files.

Optionally, the copyright holder may specify a confidence threshold for matching a specified media object, as in FIG. 5. The confidence threshold may also include aspects of metadata related to a specified media object that could be compared against the fingerprint and metadata of media objects listed in the database complied by this invention. For example, a copyright holder may supply location of media objects to be searched (as a URI). The copyright holder could additionally specify metadata for the invention to locate media objects such as Title, Author, or other types of metadata fields. The invention would still match the fingerprint of the specified media object, but would give a higher score to a matched media object with matched metadata with a matching fingerprint (within a confidence threshold) versus a media object without matching metadata. Matched by a fingerprint alone. Variations of the matching criteria may be employed as consistent with the principles of the present invention.

Step 410 outputs ancillary information of matched objects media objects (from step 408). In FIG. 5. the ancillary information of matched media objects shown is the URIs of matched media objects, although other types of ancillary information (such as the metadata of matched media objects) may be outputted as well. For example, the invention outputs the title, format type, and location of a matched media object. The outputted ancillary information of matched media objects may be modified upon the needs of a copyright holder in a method consistent with the principles of the present invention. The copyright owner is then enabled to notify the operator of a data store or a website that illicitly copied copyright materials exists (on a site) and needs to be removed.

The DRM solution, of the present invention, would also offer an option, perhaps for a fee, for automatically notifying a data store or website operator that infringing copyrighted material exists and needs to be removed. Once a fingerprint is matched, the DRM solution queries a copyright holder if they want to activate the automatic notification module. If this option is selected, the invention performs a WHOIS lookup of a URI at http://www.whois.net to determine who the Administrative Contact is of a datastore or website. Based upon the contact information, the system automatically sends an email to the Administrative contact informing the person that there is infringing media files located at the site that the contact operates. Examples of information in the e-mail would include the name of the identified media file, the contact information of the copyright owner, and a date to remove the infringing material by, information needed to comply with the Digital Millennium Copyright Act. The copyright owner then can have the DRM solution check (after a specified period, a day, week, etc.,) if such material has been removed, as the copyright owner able to pursue legal actions against the Administrative contact.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

The present invention may be embodied to update or replace the metadata relating to a media file, contained in a database, web page, storage device, media file (header or footer), URI, transport stream, electronic program guide, and other sources of metadata, by using the same processes and/or apparatuses described wherein.

Although the present invention is described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for providing a digital resource management solution for identifying media objects based on a fingerprint profile, the method comprising the steps of:
developing a fingerprint profile of a specified media object;
matching said fingerprint profile of the specified media object against the fingerprint profiles of located media objects; and
outputting ancillary information of located media objects matching said fingerprint profile.

2. A method in accordance with claim 1, wherein a user profile is provided before activation of said digital resource management solution.

3. A method in accordance with claim 2, wherein a user provides billing information before activation of said digital resource management solution.

4. A method in accordance with claim 1, wherein a threshold profile value is used for the step of matching said fingerprint profile of the specified media object.

5. A method in accordance with claim 1, wherein said fingerprint algorithms are compatible with at least one of SongPrint and Audio ID.

6. A method in accordance with claim 1, comprising of an additional step of automatically notifying an administrative contact that the located media objects may infringe a copyright.

7. A method in accordance with claim 1, wherein the matching step uses metadata related to a specific located media object from the located media objects with the fingerprint profile to match the located media objects.

8. A method in accordance with claim 7, wherein said matching step gives a higher preference to the matching fingerprint profile than to matching metadata.

9. A method in accordance with claim 1, wherein a confidence threshold is used to match the fingerprint profile to a similar fingerprint profile.

10. A method in accordance with claim 1, wherein the fingerprint profile are provided before activating the digital resource management solution.

11. A method in accordance with claim 1, wherein said located media objects are present at least one of: a web site, an file transport protocol site, a peer to peer network, a disc drive, a hard drive, a computer, a compact disc, and a digital video disc.

12. A apparatus providing a digital resource management solution for a identifying media objects based on a fingerprint profile, the apparatus comprising:
a means for developing a fingerprint profile of a specified media object;
a means for matching said fingerprint profile of the specified media object against the fingerprint profiles of located media objects; and
a means for outputting ancillary information of located media objects matching said fingerprint profile.

13. An apparatus in accordance with claim 12, wherein a user profile is provided before activation of said digital resource management solution.

14. An apparatus in accordance with claim 13, wherein a user provides billing information before activation of said digital resource management solution.

15. An apparatus in accordance with claim 12, wherein a threshold profile value is used for the step of matching said fingerprint profile of the specified media object.

16. An apparatus in accordance with claim 12, wherein said fingerprint algorithms are compatible with at least one of SongPrint and Audio ID.

17. An apparatus in accordance with claim 12, comprising of an additional step of automatically notifying an administrative contact that the located media objects may infringe a copyright.

18. A method for providing a digital resource management solution for identifying media objects based on a fingerprint profile, the method comprising the steps of:
specifying a location of media objects to be searched;
providing a fingerprint profile of a specific media object;
developing fingerprint profiles for the media objects to be searched;
matching the media objects to be search to the fingerprint profile of a specific object;
outputting data of the matching media objects to be searched.

19. The method of claim 18, wherein said process is performed with a webcrawler.

20. The method of claim 18, wherein the method is charged to a user profile on a fee basis.
